(19) United States
(12) Patent Application Publication
(10) Pub. No.: US 2026/0309534 A1
(43) Pub. Date: Oct. 8, 2026

(54) MEASURING ASSEMBLY OF A FIELD DEVICE ON A CONTAINER

(71) Applicant: VEGA GRIESHABER KG, Wolfach (DE)

(72) Inventor: Clemens Hengstler, Haslach (DE)

(21) Appl. No.: 19/482,938

(22) PCT Filed: Apr. 29, 2024
(86) PCT No.: PCT/EP2024/061737

§ 371 Date: Nov. 10, 2025

(30) Foreign Application Priority Data
May 11, 2023 (DE) 10 2023 112 392.0

(51) Int. Cl. G01F 23/263; G01F 23/284

(52) U.S. Cl. CPC G01F 23/263; G01F 23/284

(57) ABSTRACT

A measuring assembly comprising a field device which is disposed on a container having at least one strut, wherein: the field device is fastened to the at least one strut of the container by means of a fastening structure. The fastening structure is wedge-shaped and comprises a rest surface and a wedge surface running obliquely to the rest surface. The fastening structure rests on the container by means of the rest surface and is seated against the strut by means of the wedge surface, and the fastening structure is fastened to the strut by means of at least one fastening element such that the wedge surface is pulled toward the strut and is seated against the strut. The invention also relates to a field device, to an adapter, and to a method for producing a measuring assembly.

The present invention relates to a measuring assembly according to Patent Claim 1. The invention further relates to a field device according to Patent Claim 8, an adapter according to Patent Claim 9 and a method for establishing a measuring assembly according to Patent Claim 10.

Various measuring assemblies are known from prior art, in which field devices are mounted on containers.

The invention relates in particular to containers on which there is no suitable mounting option, such as a flange or threaded nozzle. In particular, these containers are storage tanks or reserve tanks made of non-metallic materials, in particular, plastics. Usually, the containers are transportable. Such tanks are usually so-called IBCS (intermediate bulk containers), which comprise a blister and are surrounded on the outside by a grating with a plurality of metal struts.

In order to monitor the condition of the filling material in the container, a field device is to be installed on the container despite the lack of a pre-installed mounting option. The arrangement of the field device should be as intuitive and cost-effective as possible and simultaneously enable a stable arrangement of the field device on the container.

Solutions known from prior art sometimes comprise complicated adapter solutions. In some cases, connections to the container are also known, wherein part of the connection must be disposed of after removing the field device.

The underlying object of the invention is therefore to provide a measuring assembly of a field device on a container, a field device, an adapter and a method for the establishment of a measuring assembly, which enable a cost-effective, simple and as resource-saving, detachable attachment of a field device to a container.

According to the invention, the solution to the object is carried out with the features of the independent claims. Other practical embodiments and advantages are described in connection with the dependent claims.

The invention relates to a measuring assembly comprising a field device which is arranged on a container with at least one strut. Field devices are devices that are used in the “field”, i.e., in an area outside of control rooms. Field devices are in particular actuators, sensors, data collectors (data loggers) and transmitters. In particular, the field device is connected to a superordinate unit, for example a control system or a control unit. This superordinate unit is used in particular for process control, process visualization and/or process monitoring. In particular, the field device can be a monitoring and optimisation sensor (M&O sensor). In particular, such an M&O sensor collects information that is sent to a cloud or an internal server.

Alternatively, the field device can also be a field device for determining a location, wherein the position of a container is sent to a superordinate unit to track the position of a container.

In particular, the field device is a self-sufficient field device, which does not comprise a wired power supply and communication link. In particular, the field device comprises an energy storage device.

In particular, the field device comprises a housing, a sensor unit and an electronic module arranged in the housing. The measured process variables are usually evaluated and are preferably used to monitor containers and the filling material filled into them.

The field device is in particular a radar sensor or a capacitive sensor for detecting a point level or fill level of filling material in the container. Alternatively, it is a position sensor.

The container comprises at least one strut. The container is made of plastic in particular and comprises a blister in which the filling material is arranged and a grating with a plurality of struts arranged around the blister. Specifically, it is an IBC. At least one strut is usually made of metal.

In the case of a radar sensor, the field device is located in particular on the top side of the container and preferably on a strut extending along the top side, preferably in the middle of the top side.

It is also conceivable—for example, for a capacitive sensor—to arrange the field device on a strut arranged on the side.

The field device is directly or indirectly attached to the strut of the container with a fastening structure. As explained below, the fastening structure can be either the housing of the field device itself or an adapter that indirectly connects the field device to the strut.

The fastening structure is wedge-shaped and comprise a flat support surface and a wedge surface running obliquely to it. In particular, the support surface and the wedge surface form an acute angle. The support surface lies on the container, and in particular on the blister, and the wedge surface is seated against the strut. The wedge surface can be flat, comprise an arc-shaped course or comprise a curve or recess, in particular in such a way that the strut is held in it.

Furthermore, the main body is attached to the strut by means of a fastening element in such a way that the wedge surface is pulled in the direction of the strut and is seated against it.

The wedge shape of the fastening structure and additionally the fastening element ensure a stable position of the field device. The support surface lies flat against the container and is pressed against the surface of the container with a certain pressure. No liquid can collect underneath it. If the fastening structure is the housing of the field device, it can be easily and intuitively attached directly to the strut. If the fastening structure is an adapter, it can be used to attach existing field devices to the container. Here, the geometrical design of the housing provides a torsion-proof and stable position of the field device.

In order to improve the tilting stability of the field device, the support surface of the fastening structure extends under the strut, particularly in a cross-section of the strut so that the fastening structure extends on both sides of the strut. By fastening it to the strut by means of the fastening element and lying of the support surface on the side of the strut on the container, the fastening structure and thus also the field device cannot twist around the attachment point on the strut (pivot point).

In particular, a predominant of the fastening structure and the field device with sensor element and electronic module extend on the side of the strut where the wedge surface lies on the strut and only a smaller part of the fastening structure extends under the strut to the other side of the strut.

In a practical embodiment, the wedge surface comprises a shoulder at the side facing the support surface, i.e., at the transition to the support surface. In particular, a shoulder means that the wedge surface first merges into a shoulder face running parallel to the support surface. The shoulder extends in particular on the side of the strut facing away from the wedge surface (viewed in cross-section).

The shoulder can reduce the size of the fastening structure, particularly at small angles between the wedge surface and the support surface, the length of the fastening structure can be reduced.

In particular, the side of the wedge surface facing away from the support surface comprises a stop. The stop here refers to a surface that runs at an angle to the wedge surface. The stop effectively counteracts slipping of the fastening structure below the strut.

In another practical embodiment, the fastening element is a band-shaped tie element. For example, the tie element can be a tape, a cable tie or a hose clamp. Tapes, cable ties or hose clamps are widely used fastening elements and can therefore be used intuitively. In addition, these are cost-effective parts. If the fastening structure is detached from a container, it can be partially reused or only a small amount of waste is generated. By means of the fastening element, the fastening structure is fixed to the strut in such a way that the wedge surface seats against the strut. In particular, in the longitudinal direction of the strut, a plurality of fastening elements, in particular two, which are objected to from each other, are arranged on the fastening structure.

In particular, such a band-shaped tie element can be guided through a channel integrated into the fastening structure. The tie element is then fixed in the channel in a form-fitting manner to prevent lateral slipping (in the longitudinal direction of the strut) . Alternatively, the tie element can be arranged around an exposed offset section of the fastening structure.

Alternatively, or in addition to this, the fastening element includes a clamping bracket by means of which the fastening structure is held in place on the strut. Such a clamping element can be in particular a spring-loaded swivel arm, which is arranged on the fastening structure, and which at least partially encloses the strut. In particular, the length of the swivel arm can be extended against a spring force in order to place the swivel arm around a strut. The spring force reduces the length again, and the fastening structure is then pulled in the direction of the strut. The clamping element can also be spring-loaded clamps or pliers that press the fastening structure against the strut. After loosening the clamping element, it can be reused to attach another fastening structure.

In particular, the support surface comprises a spring that exerts a spring force downwards in the direction of the container. The spring is located in particular in the part of the fastening structure which extends under the strut, on the side of the strut facing away from the wedge surface. By means of the spring, an additional force can be applied to the fastening structure, which counteracts twisting and increases the contact force on the part on the other side of the pivot point of the fastening structure particularly the part with the sensor element. In addition, deformations on the container can be compensated for.

The invention also relates to a field device for arrangement on a container with at least one strut. The field device comprises a housing that comprises a wedge-shaped fastening structure as described above with a support surface and a wedge surface running obliquely to it. Here, the housing of the field device itself is designed in such a way that it can be attached directly to the strut. For details of the fastening structure, reference is made to this description. In particular, the housing is designed to be attached to the strut by means of a fastening element. For example, the housing can comprise an integrated channel or similar so that a ribbon-shaped tie element can be guided around part of the housing. Alternatively, or additionally, a clamping element can be formed on the housing.

The invention additionally relates to an adapter for the arrangement of a field device on a container with a strut, wherein the adapter comprises a wedge-shaped fastening structure with a support surface and a wedge surface running obliquely to it. Again, reference is also made to the present description with regard to the fastening structure. In particular, the adapter comprises a field device fastening section where the field device can be connected to the adapter. The field device is connected to the adapter by means of screws or clips. In particular, the adapter is designed to be attached to the strut by means of a fastening element. For example, the adapter can comprise an integrated channel or something similar so that a ribbon-shaped tie element can be guided around a part of the adapter. Alternatively, or additionally, a clamping element can be formed on the adapter.

Furthermore, the invention relates to a method for the establishing of a measuring assembly, in particular a measuring assembly as described above with a field device on a container with at least one strut. The field device is positioned on the container by means of a wedge-shaped fastening structure so that a support surface is against the container and a wedge surface is against the strut, and wherein the fastening structure is fixed to the strut by means of a fastening element in such a way that the wedge surface is pulled against the strut.

With regard to the advantages of the method and other features, reference is made to the description above.

In the following, further practical embodiments and advantages are described in connection with the figures. The figures show:

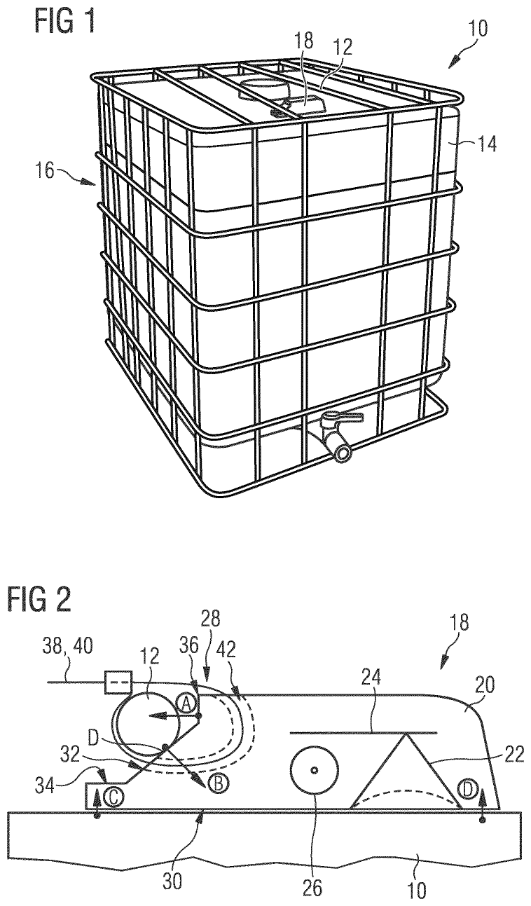

FIG. 1 a container comprising a blister and a plurality of struts and a field device arranged on the top side in a perspective view,

FIG. 2 a schematic illustration of a measuring assembly with a field device in a first embodiment on a container with a strut, in a cross-section through the strut,

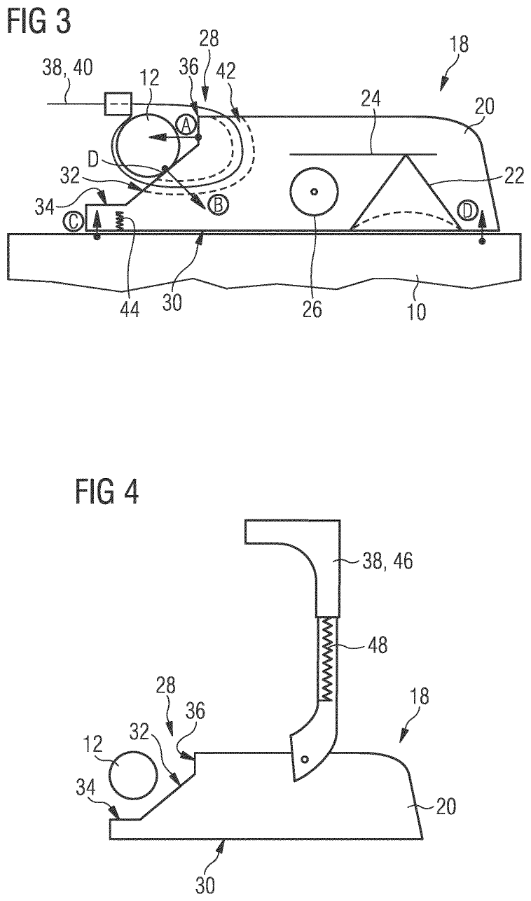

FIG. 3 a schematic illustration of a measuring assembly with a field device in a second embodiment on a container with a strut, in a cross-section through the strut,

FIG. 4 a schematic illustration of a measuring assembly with a field device in a third embodiment with a swivel arm in a first position on a container with a strut, in a cross-section through the strut,

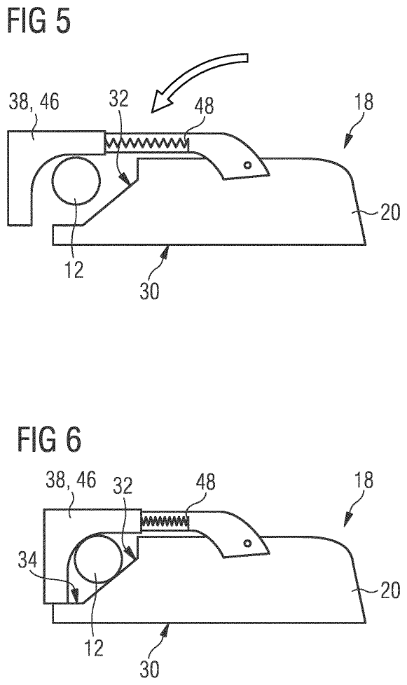

FIG. 5 the measuring assembly from FIG. 4 with the swivel arm in a second position and

FIG. 6 the measuring assembly from FIGS. 4 and 5 with the swivel arm in a third position.

In FIG. 1 a container 10 with a plurality of struts 12 is shown. In the present case, it is a so-called IBC, which here comprises a plastic blister 14 for holding filling material. Around blister 14 is a grating 16 consisting of a plurality of struts 12. The struts 12 are made of metal. In the present case, a field device 18 is arranged on the top side of container 12 (shown here only schematically). This is a radar measuring device for determining the fill level in container 10.

In FIG. 2 a measuring assembly with a field device 18 in a first embodiment and with a container 10 with a strut 12 is schematically illustrated.

In the present case, field device 18 comprises a housing 20, wherein a sensor element 22 in the form of a radar antenna, an electronic module 24 and an energy storage device 26 are arranged in housing 20. The housing 20 is oriented in such a way that the radar antenna radiates in the direction of container 10.

In the present case, the housing 20 comprises a wedge-shaped fastening structure 28 with a flat support surface 30 and a wedge surface 32 running obliquely to it. The support surface 30 lies on container 10—in this case the blister 14—and the wedge surface 32 is seated against the strut 12. The wedge surface 32 is also flat here. However, other geometries, such as curvatures or arc-shaped gradients, are also conceivable for the wedge surface 32.

A shoulder 34 is formed on the side of the wedge surface 32 facing the support surface 30, i.e., between the wedge surface 32 and the support surface 30. The shoulder extends parallel to the support surface 30.

In addition, a stop 36 is formed on the side of the wedge surface 32 facing away from the support surface 30. The stop 36 extends at an angle to the wedge surface 32.

The housing 20 is attached to the strut 12 by means of a fastening element 38 in the form of a cable tie 40 so that the wedge surface 32 is pulled to the strut 12 and is seated against it. The cable tie 40 runs through a channel 42 integrated into the housing 20.

The attachment point of the wedge surface 32 at the strut 12 simultaneously represents the pivot point D of the housing 20 around the strut 12. The housing 12 is secured against twisting, since the housing 12 extends with one part of the wedge surface 32 and the offset section 34 under the strut 12.

By tightening the cable tie 40, a force A is exerted on the housing 20 and thereby the field device 18 is pressed to the left against the strut 12. Through the sloping wedge surface 32, the housing 20 is pressed downwards against the container 10 by tightening against the strut 12 with the force B.

Since the housing 20 comprises a flat support surface 30 and this extends in front of and behind the pivot point D and thus to the side of the strut 12, the housing 18 cannot twist around the strut 12, but is fixed flat on the container 10 according to the forces C and D.

In the following, the same reference numbers are used to describe further embodiments for identical or at least functionally identical components as to describe the first embodiment.

FIG. 3 shows a measuring assembly with a field device 18 in a second embodiment. This second embodiment differs from the first embodiment in that the support surface 30 comprises a spring 44. The spring 44 is arranged in the area of the shoulder 34 and acts a spring force on the container 10 and thus counteracts twisting with an additional force on the housing 20.

FIGS. 4 to 6 show a measuring assembly with a field device 18 in a third embodiment. Here, the housing 20 comprises a spring-loaded swivel arm 46 as fastening element 38. The length of the swivel arm 46 is telescopically adjustable and comprises a spring 48. The swivel arm 46 can be extended against the spring force.

The swivel arm 46 is shown in an open position in FIG. 4. In order to place the swivel arm 46 around the strut 12, the swivel arm 46 is extended against the spring force and swivelled in relation to the housing 20 so that the swivel arm 46 encloses the strut 12 (see FIG. 5).

FIG. 6 then shows the final assembly position, wherein the wedge surface 32 is pulled against the strut 12 by the spring force in the swivel arm 46 and is held to it.

### Reference List

10 container
12 strut
14 blister
16 grating
18 field device
20 housing
22 sensor element, radar antenna
24 electronics module
26 energy storage device
28 fastening structure
30 support surface
32 wedge surface
34 shoulder
36 stop
38 fastening element
40 cable tie
42 channel
44 spring
46 swivel arm
48 spring
D pivot point
A, B, C. D force

1. Measuring assembly comprising a field device which is arranged on a container with at least one strut, wherein the field device is attached by means of a fastening structure to the at least one strut of the container, wherein
the fastening structure is wedge-shaped and comprises a support surface and a wedge surface running obliquely thereto, wherein the fastening structure lies with the support surface on the container and with the wedge surface on the strut, and wherein the fastening structure is attached to the strut by means of at least one fastening element in such a way that the wedge surface is drawn in the direction of the strut and is seated against it.

2. The measuring assembly according to claim 1, wherein
the support surface extends in a cross-section on both sides of the strut.

3. The measuring assembly according to claim 1, wherein
the side of the wedge surface facing the support surface comprises a shoulder.

4. The measuring assembly according to claim 1, wherein
the side of the wedge surface facing away from the support surface comprises a stop.

5. The measuring assembly according to claim 1, wherein
the fastening element is a band-shaped tie element.

6. The measuring assembly according to claim 1, wherein
the fastening element comprises a clamping element by means of which the fastening structure is held clamped to the strut.

7. The measuring assembly according to claim 1, wherein
the support surface comprises a spring which exerts a spring force in the direction of the container.

8. A field device for arrangement on a container with at least one strut, wherein the field device comprises a housing with a wedge-shaped fastening structure with a support surface and a wedge surface running obliquely thereto.

9. An adapter for the indirect arrangement of a field device on a container with at least one strut, wherein the adapter comprises a wedge-shaped fastening structure with a support surface and a wedge surface running obliquely thereto.

10. A method for establishing a measuring assembly of a field device on a container having at least one strut, wherein the field device is positioned on the container by means of a wedge-shaped fastening structure so that a support surface is attached to the container and a wedge surface is attached to the strut and wherein the fastening structure is fixed to the strut by means of a fastening element in such a way that the wedge surface is pulled against the strut.
